(19) United States
(12) Patent Application Publication
(10) Pub. No.: US 2010/0024889 A1
(43) Pub. Date: Feb. 4, 2010

(54) Unidirectional Flow Device and Methods of Use

(75) Inventors: David Joseph Walker, Lafayette, LA (US); Cody Hansen, Broussard, LA (US)

Correspondence Address: JONES & SMITH , LLP, 2777 ALLEN PARKWAY, SUITE 800, HOUSTON, TX, 77019, US

(73) Assignee: BJ SERVICES COMPANY, Houston, TX (US)

(21) Appl. No.: 12/511,890

(22) Filed: Jul. 29, 2009

Related U.S. Application Data
(60) Provisional application No. 61/085,100, filed on Jul. 31, 2008.

(51) Int. Cl. F17D 3/00; F16K 15/00

(52) U.S. Cl. 137/12; 137/512

(57) ABSTRACT

In some embodiments, apparatus for allowing one-way flow of fluid into or out of a tubular member includes a base pipe having at least one port formed therein. At least one valve is engaged with the base pipe, associated with at least one port and capable, at least temporarily, of allowing fluid flow in one direction and disallowing fluid flow in the opposite direction through the associated port(s).

This application claims priority to the U.S. provisional patent application Ser. No. 61/085,100 filed Jul. 31, 2008, entitled “Unidirectional Flow Device and Methods of Use”, the disclosure of which is hereby incorporated by reference herein in its entirety.

### FIELD OF THE INVENTION

The present invention relates generally to fluid flow systems. In some embodiments, the present invention relates to systems, apparatus or methods capable of allowing unidirectional flow through at least one port in a tubular member with the use of one or more component associated with the tubular member.

### BACKGROUND OF THE INVENTION

In various fluid flow operations, it is often necessary to allow fluid flow in only one direction (“unidirectional flow”) at certain phases or locations. In some instances, it is desirable to allow fluid flow into a tubular member through one or more ports formed in the wall of the tubular member and disallow fluid flow in the other direction. In other instances, the opposite unidirectional flow arrangement is useful.

In subsurface hydrocarbon recovery operations, there are occasions when it is desirable to allow one-way flow into or out of a tubing. For example, one-way flow into the tubing may be preferred in a production or fluid recovery mode, while one-way flow out of the tubing may be preferred in an injection mode. During the use of multi-zone hydrocarbon well treatment/production systems, unidirectional fluid flow through sand-control screens is often desirable. For example, when treating lower zones, it is often necessary to block fluid flow out of the upper screen(s) to avoid losing fluid into the upper zones. For another example, during reverse-out procedures, it is often desirable to prevent the outflow of fluid through one or more screen.

Various existing and proposed apparatus and techniques for allowing only unidirectional flow are believed to have disadvantages. Accordingly, there exists a need for apparatus and methods useful with fluid flow systems having one or more of the following attributes, capabilities or features: reduces or prevents the flow of fluid out of a tubular member through at least one port formed therein; reduces or prevents the inflow of fluid into a tubular member through at least one port formed therein; allows unidirectional flow of fluid into or out of a tubular member by one or more components at least substantially contained within one or more ports formed in the tubular member; allows unidirectional flow of fluid into or out of a tubular member with the use of one or more automatically actuated components anchored to the tubular member; allows unidirectional flow of fluid into or out of a tubular member by one or more non-mechanically actuated or locally pressure-actuated components associated with the tubular member; allows unidirectional flow of fluid into or out of a tubular member with the use of one or more one-way valves engaged with the tubular member; includes at least one one-way valve at least substantially disposed within a port of a tubular member to allow unidirectional flow therethrough; initially allows only unidirectional fluid flow into or out of a tubular member and ultimately allows bidirectional flow therethrough; allows unidirectional flow of fluid into or out of a tubular member without requiring additional components other than those carried by the tubular member; includes apparatus capable of allowing unidirectional flow of fluid into or out of a tubular member without occupying substantial space outside or around the tubular member; allows unidirectional flow of fluid into or out of a tubular member through at least one port therein without the need to insert or run an additional pipe, fluid blocking system or other component inside the tubular member; allows unidirectional flow of fluid into or out of a tubular member through at least one port therein without reducing the size of the bore or inner diameter of the tubular member; includes systems, apparatus, methods or a combination thereof that automatically allows unidirectional flow of fluid into or out of a tubular member based upon differential pressure; includes systems, apparatus, methods or a combination thereof that allow unidirectional flow of fluid into or out of a tubular member having a larger inner diameter work space with the same size outer diameter as compared to known prior art systems, apparatus and methods; allows unidirectional flow of fluid into or out of a tubular member with optimal sizing of the inner diameter of the tubular member; includes systems, apparatus, methods or a combination thereof that allow unidirectional flow of fluid into or out of a tubular member and are easier and more cost efficient to manufacture and/or implement than known prior art; includes locally pressure-actuated apparatus for fluid loss control in a downhole screen assembly; includes systems, apparatus, methods or a combination thereof that provide fluid loss control in a downhole screen assembly without the use of a shifting tool or additional tubing; is useful for fluid loss control in multiple zones of a multi-zone hydrocarbon well treatment/production system; simplifies operations of a multi-zone hydrocarbon well treatment/production system; is useful in a multi-zone hydrocarbon well treatment/production system to prevent fluid loss in one or more zones during treatment of another one or more zones; is useful to allow reverse-out procedures in downhole operations without having to close any sleeves or isolate any screen sections with isolation tubing; is useful to automatically prevent flowback from a well during injection operations; or any combination thereof.

It should be understood that the above-described examples, features and/or disadvantages are provided for illustrative purposes only and are not intended to limit the scope or subject matter of the claims of this patent or any other patent application or patent claiming priority hereto. Thus, none of the appended claims or claims of any related application or patent should be limited by the above discussion or construed to address, include or exclude the cited examples, features and/or disadvantages, except and only to the extent as may be expressly stated in a particular claim.

### BRIEF SUMMARY OF THE INVENTION

In some embodiments, the present disclosure involves apparatus for allowing one-way flow of fluid into or out of a tubular member useful in a well bore in connection with hydrocarbon recovery operations. A base pipe includes a plurality of ports that allow fluid communication between the interior of the base pipe and the well bore. A one-way valve is associated with and at least substantially disposed within each port. Each one-way valve is capable of allowing fluid flow in one direction and at least substantially disallowing fluid flow in the opposite direction through the associated port.

In various embodiments, the present disclosure involves apparatus for allowing unidirectional flow of fluid into or out of a pipe string. A base pipe includes at least one port that allows fluid communication between the base pipe and the well bore. At least one valve closure member is anchored to the base pipe and associated with at least one the port. Each valve closure member is biased in a closed position in which it at least substantially prevents fluid flow through the associated port. Each valve closure member is movable into at least one open position based upon a sufficient change in the differential pressure between the well bore and the interior of the base pipe. In an open position, each valve closure member allows fluid flow through the associated port.

There are embodiments of the present disclosure that involve a sand control-type screen assembly useful as part of a tubing string in a well bore in connection with hydrocarbon recovery operations. A base pipe includes a wall and at least one port formed therein. Each port allows fluid communication from the interior to the exterior of the base pipe. At least one non-mechanically actuated valve is anchored to the base pipe and associated with a port. Each valve is capable of allowing fluid flow in one direction and disallowing fluid flow in the opposite direction through the associated port. At least one filter medium extends around the base pipe over the ports.

In many embodiments, the present disclosure involves a method of allowing one-way flow of fluid into a tubing string useful in a well bore in connection with hydrocarbon recovery operations. A base pipe is provided in the tubing string. Fluid is allowed to flow axially through the base pipe without exiting through a plurality of ports formed in the base pipe. Upon sufficient application of fluid pressure from the well bore on at least one valve associated with a port in the base pipe, each valve is allowed to open and permit the flow of fluid from the well bore through its associated port and into the base pipe. Thereafter, upon a sufficient decrease in the application of fluid pressure on the at least one valve from the well bore, each valve is allowed to close and at least substantially prevent the flow of fluid through its associated port.

In numerous embodiments, the present invention involves a method of allowing one-way flow of fluid out of a tubing string useful in a well bore in connection with hydrocarbon recovery operations. A base pipe is provided in the tubing string. Upon sufficient application of fluid pressure from the interior of the base pipe on at least one valve anchored to the base pipe and associated with a port formed therein, each valve is allowed to open and permit the flow of fluid from the base pipe through the associated port and into the well bore. Thereafter, upon a sufficient decrease in the application of fluid pressure on the at least one valve from the interior of the base pipe, each valve is allowed to close and at least substantially prevent the flow of fluid through the associated at least one port.

Accordingly, the present disclosure includes features and advantages which are believed to enable it to advance fluid flow technology. Characteristics and advantages of the present invention described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is a partial cross-sectional view of an example tubular member including an embodiment of a one-way flow system in a valve-open state in accordance with the present disclosure;

FIG. 2 shows the embodiment of the one-way flow system of FIG. 1 in a valve-closed state;

FIG. 3 is a partial cut-away view of another example screen assembly including a base pipe having an embodiment of a one-way flow system in accordance with the present disclosure;

FIG. 4 is a cross-sectional view of an embodiment of a one-way valve in accordance with the present disclosure;

FIG. 5 is a cross-sectional view of another embodiment of a one-way valve in accordance with the present disclosure;

FIG. 6 is a cross-sectional view of another embodiment of a one-way valve in accordance with the present disclosure;

FIG. 7 is a partial cut-away view of an example screen assembly including an embodiment of a one-way flow system in accordance with the present disclosure;

FIG. 8 is a partial cut-away view of another example screen assembly including an embodiment of a one-way flow system in accordance with the present disclosure;

FIG. 9 is a partial cross-sectional view of part of an exemplary multi-zone well treatment/production system that includes a pair of one-way flow systems in accordance with an embodiment of the present disclosure and shows a first exemplary fluid flow path; and

FIG. 10 is partial cross-sectional view of part of the exemplary multi-zone well treatment/production system shown in FIG. 9 and illustrating a second exemplary fluid flow path.

### DETAILED DESCRIPTION OF PREFERRED EMBODIMENTS

Characteristics and advantages of the present invention and additional features and benefits will be readily apparent to those skilled in the art upon consideration of the following detailed description of exemplary embodiments of the claimed invention and referring to the accompanying figures. It should be understood that the description herein and appended drawings, being of example embodiments, are not intended to limit the claims of this patent application, any patent granted hereon or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout various portions (and headings) of this patent application, the terms “invention”, “present invention” and variations thereof are not intended to mean the invention of every possible embodiment of the invention or any particular claim or claims. Thus, the subject matter of each such reference should not be considered as necessary for, or part of, every embodiment of the invention or any particular claim(s) merely because of such reference. Also, it should be noted that reference herein and in the appended claims to components and aspects in a singular tense does not necessarily limit the present invention to only one such component or aspect, but should be interpreted generally to mean one or more, as may be suitable and desirable in each particular instance.

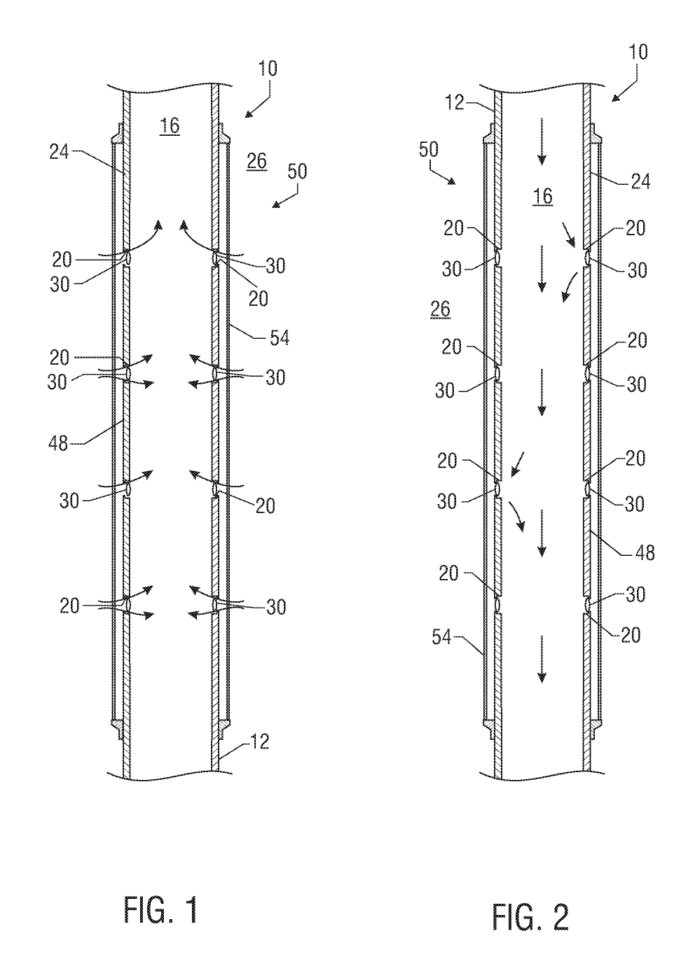

Referring initially to the embodiment of FIG. 1, an example one-way flow system 10 includes a tubular member 12 having at least one interior space, or axially-oriented bore 16. The illustrated tubular member 12 includes at least one port 20 extending through the wall 24 thereof. The port 20 fluidly connects the bore 16 of the tubular member 12 to the exterior 26 of the tubular member 12. A valve closure member, or valve, 30 is shown associated with each port 20. Each illustrated valve 30 automatically allows the flow of fluid through the associated port 20 in only one direction.

The illustrated system 10 is configured so that the valves 30 permit fluid flow into the bore 16 through the associated ports 20 from the exterior 26 of the tubular member 12, while preventing fluid flow in the opposite path (e.g. FIG. 2). This general flow arrangement may sometimes be referred to herein as the “inflow” configuration, or variations thereof. In other instances, the system 10 may be configured so that the valves 30 instead allow fluid flow from the bore 16 of the tubular member 12 through the port(s) 20 to the exterior 26 of the tubular member 12, while disallowing fluid flow in the opposite path (e.g. valve 30, FIG. 6). This general flow arrangement may sometimes be referred to herein as the “outflow” configuration, or variations thereof.

When multiple port 20/valve 30 combinations are provided in the tubular member 12 or a portion thereof, it may be desirable for all of the valves 30 to allow flow in the same direction, either in an inflow or an outflow configuration. Alternately, the system 10 may have a hybrid arrangement that includes certain valves 30 in an inflow configuration and other valves 30 in an outflow configuration. Thus, the present disclosure is not limited by the flow configuration of the valve(s) 30.

Still referring to the embodiment of FIG. 1, the illustrated system 10 is arranged so that each valve 30 operates independently of the other valves 30. In other embodiments, multiple or all of the valves 30 may be interconnected or otherwise configured to open and/or close together. Further, some embodiments may include arrangements having a single valve 30 associated with multiple ports 20.

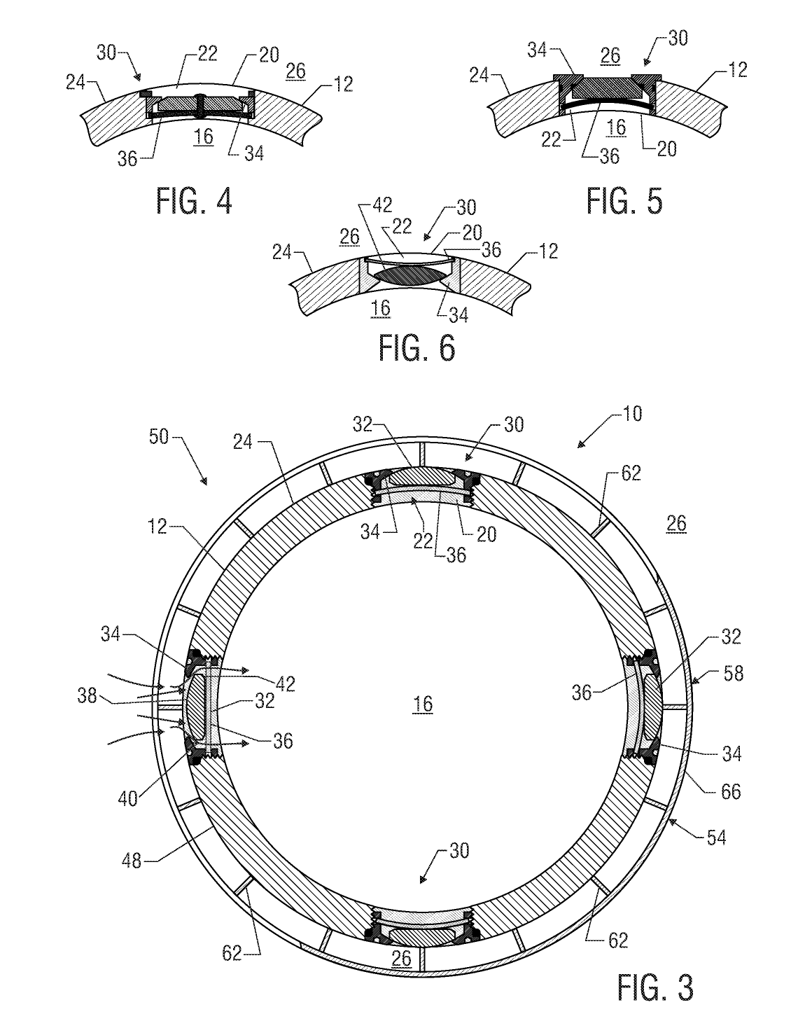

In another aspect of the present disclosure, referring to FIG. 3, each valve 30 may, if desired, be carried by, engaged with or anchored to the tubular member 12. In some embodiments, each valve 30 may be at least substantially contained within the internal space 22 of its associated port 20. In such instance, the valve 30 will not extend into or occupy substantial space outside its associated port 20, either in the bore 16 of the tubular member 12 or on the exterior 26 of the tubular member 12. In FIGS. 3 and 6, for example, each valve 30 is fully contained within the space 22 of the associated port 20. In contrast, FIG. 5 shows an example valve 30 that extends partially beyond the periphery of the tubular member 12, but is considered substantially contained within the space 22 of the port 20. Generally, a valve 30 is substantially contained within a port 20 if, in its open and closed positions, the valve 30 extends outside the port 20 in either direction by a distance of no greater than approximately one-half the average thickness of the wall 24 of the tubular member 12. However, the present invention is not limited to the use of valves 30 that are engaged with the tubular member 12 or entirely or substantially contained with the space 22 of the associated ports 20.

Referring again to the embodiment of FIG. 3, the valves 30 may include any suitable components, configuration and form, and may operate in any suitable manner. For example, the valve 30 may be a poppet or ball valve, as is or becomes known. In FIG. 3, each illustrated valve 30 includes a sealing member 32 generally biased in a closed position against a seat 34 by a biasing member 36. In other embodiments, the valve 30 may include multiple sealing members 32, seats 34 and/or biasing members 36.

The sealing member 32, seat 34 and biasing member 36, when included, may have any suitable form, construction and configuration and may operate in any suitable manner. For example, in FIGS. 3-6, the sealing members 32 are solid members having a variety of cross-sectional shapes, as shown, and may be constructed of any suitable material, such as steel, aluminum, bronze, ceramic or a polymer-based material or composite.

Still referring to FIGS. 3-6, the illustrated seats 34 are different varieties of metallic ring-like brackets, each rigidly anchored or embedded within its associated port 20. However, the seats 34 may have any other suitable configuration and be constructed of any suitable material. The illustrated biasing members 36 are leaf springs secured at their ends to the corresponding seats 34. However, the biasing members 36 may be constructed of any suitable spring-like or other material, such as coil springs or Belleville washers. In the example of FIG. 4, the biasing member 36 and sealing member 32 are connected, such as with a bolt or other suitable connector.

Referring again to FIG. 3, in this embodiment, the biasing member 36 is secured to the seat 34 behind the sealing member 32 to provide a biasing force on the back 42 of the sealing member 32. Under the biasing force of the biasing member 36, a face 38 of the sealing member 32 sealingly engages at least one lip 40 of the seat 34 to provide a generally fluid-tight or absolute seal.

In other embodiments, a fluid-tight or absolute seal may not be achieved by the valve 30. For example, the sealing member 32 or seat 34 may be perforated or include openings to allow some fluid bypass into or through the associated port 20, as desired. For another example, the biasing force of the biasing member 36 upon the sealing member 32 may be insufficient to cause a fluid-tight or absolute seal. For still a further example, the face 38 of the sealing member 32 and/or the lip 40 of the seat 34 may have a shape, texture or one or more other quality that allows a non-fluid tight seal. Further, the operating environment or particular application of the one-way flow system 10 may cause or allow a non-fluid tight seal.

In some embodiments, the sealing or valve-action of the valve 30 may change over time or upon the occurrence of one or more event. For example, the biasing member 32 may weaken or wear out over time, allowing bidirectional fluid flow through the associated port 20. For another example, the valve 30 may be constructed at least partially of a material capable of deteriorating, causing the valve 30 to ultimately remain open or non-operational, allowing bidirectional fluid flow through the associated port 20. Any suitable material may be used to allow deterioration of one or more component of the valve 30. For example, the sealing member 32 may be constructed of one or more material, such as an aluminum compound or phenolic resin, which deteriorates upon sufficient contact with an activating agent, such as an acid or oil. For another example, the sealing member 32 may be constructed at least partially of a material or compound that wears due to use or over time, such as an elastomeric outer coating.

Referring still to FIG. 3, upon the application of pressure to the front face 38 of the sealing member 32, the biasing member 36 is capable of flexing, deforming or bending in the opposite direction, allowing the sealing member 32 to be unseated from the seat 34. Under sufficient pressure from the exterior 26 of the tubular member 12, the sealing member 32 will be pushed off the seat 34, breaking the seal therebetween and allowing fluid flow through the port 20. The illustrated valve 30 is thus movable into at least one open position based upon an appropriate change in the differential pressure between the interior and exterior 26 of the tubular member 12 at the location of the valve 30, and is thus locally pressure-actuated. The exemplary valve 30 is non-mechanically actuated and considered automatically movable between open and closed positions, as it does not require mechanical actuation, such as with a shifting tool, additional tubing or other external component, or any other positive action directed from the surface. However, the present invention is not limited to valves that are non-mechanically actuated or the particular embodiment shown and described herein.

In this embodiment, each valve 30 is configured in an inflow configuration, allowing fluid flow into the bore 16 of the tubular member 12 from the exterior 26 of the tubular member 12 when the valve 30 is open. The inflow configuration may be useful, for example, during production phases of subsurface hydrocarbon recovery operations. In contrast, the valve 30 of FIG. 6, for example, provides an outflow configuration, allowing fluid flow out of the bore 16 of the tubular member 12 when the valve 30 is open. This configuration may be useful, for example, during injection phases of subsurface hydrocarbon recovery operations. However, the valves 30 may operate in any desired manner.

The one-way flow system 10 of the present disclosure may be used in any desirable application. Thus, the particular use of the system 10 is not limiting upon the present disclosure. In the embodiment of FIG. 1, the tubular member 12 is a base pipe 48 of a screen assembly 50 useful as part of a concentric pipe string arrangement for subsurface hydrocarbon recovery operations. In addition to the base pipe 48, the screen assembly 50 may have any suitable components of any desired configuration, construction and operation. Accordingly, when the one-way flow system 10 is included in a screen assembly 50, the present disclosure is not limited by the other components of the screen assembly 50.

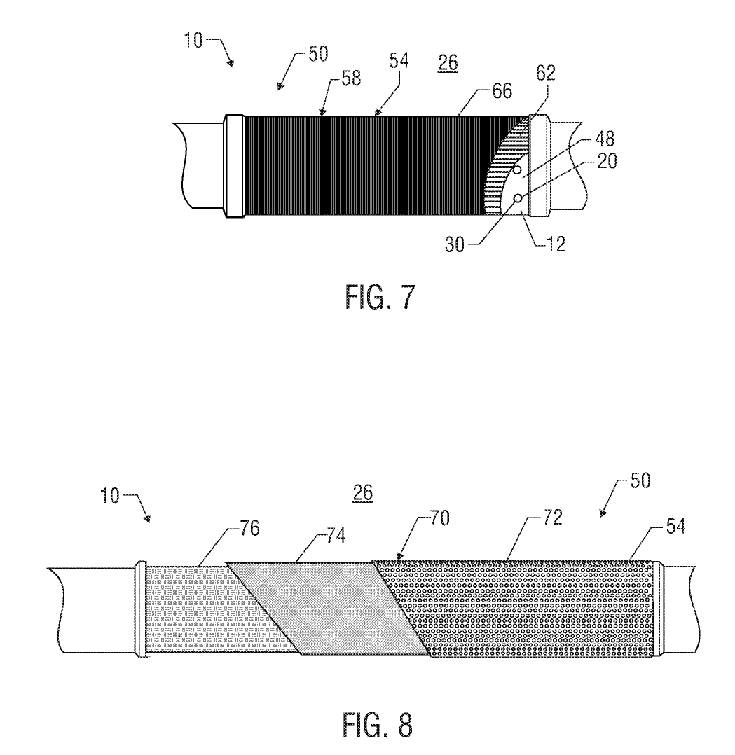

In this embodiment, the screen assembly 50 includes at least one filtering medium, or screen member, 54 extending concentrically around the base pipe 48 so that all fluid flowing into or out of the ports 30 will pass through the screen member 54. The screen member 54 may have any desired form, as is or becomes known. In the embodiment of FIG. 3, for example, the screen member 54 is a wire wrap sand screen jacket 58. For example, the screen jacket 58 may include multiple elongated ribs 62 arranged longitudinally in a circular pattern on the outside of the base pipe 48 and one or more wire 66 radially wound around the ribs 62 in multiple wraps (e.g. FIG. 7). For another example, referring to FIG. 8, the screen member 54 may be a premium-type sand control screen 70 having multiple layers of filter media, such as an outer shroud 72, inner shroud 76 and intermediate filter media 74. It should be noted, however, that any desired screen arrangement may be used, such as those offered by the present assignee, B.J. Services Company. Further, the one-way flow system 10 of the present disclosure may be used in applications other than as part of a screen assembly 50.

In some embodiments, the one-way flow system 10 may be useful in a multi-zone hydrocarbon well treatment/production system. In a single trip multi-zone treatment/production system, for example, multiple formation production levels or zones may be isolated, individually treated, then re-isolated. After all the desired zones are completed, production is run and the zones may be selectively produced—all in a single trip downhole. An example currently commercially available multi-zone system is the Multi-Zone Single “MST” Trip System of the present assignee, B.J. Services Company.

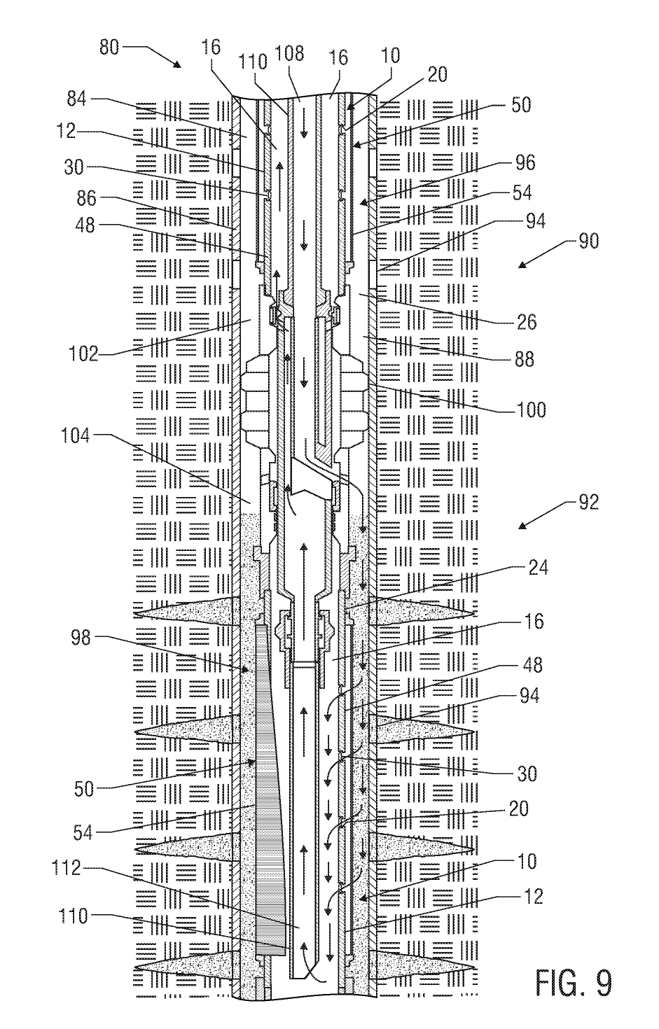

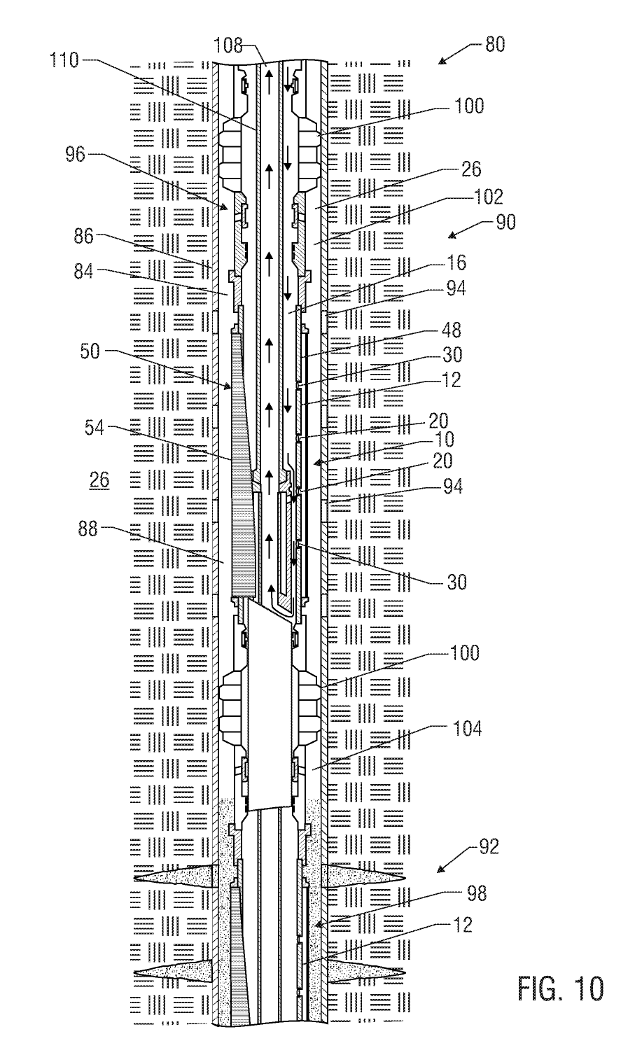

FIGS. 9 and 10 illustrate the one-way flow system 10 of the present disclosure used in an exemplary single trip multi-zone treatment/production system 80 disposed in a well bore 84. The illustrated well bore 84 is shown having a casing 86. Upper and lower production levels, or zones, 90, 92 of a hydrocarbon producing reservoir in the surrounding earthen formation are accessible through respective perforations 94 in the casing 86. An annulus 88 is formed between the casing 86 and the system 80. However, this arrangement is not required. Any other suitable or desirable arrangement may be used.

Referring to the embodiment of FIG. 9, the illustrated single trip multi-zone system 80 is shown having upper and lower equipment sections 96, 98. Each section 96, 98 includes a screen assembly 50 having a screen member 54 and base pipe 48 configured and functional similarly as described above with respect to one or more of the embodiments of FIGS. 1-8. In both screen assemblies 50, the valves 30 are configured in an inflow configuration. The screen assemblies 50 of the upper and lower sections 96, 98 are shown adjacent to upper and lower annulus portions 102, 104, respectively. The upper and lower sections 96, 98 are each flanked by a packer 100 useful to isolate the respective sections 96, 98 and corresponding annulus portion 102, 104, as is and becomes known. The system 80 is thus arranged to allow formation fluid from the upper production zone 90 to flow into the upper annulus portion 102 and the screen assembly 50 of the upper equipment section 96, and formation fluid from the lower production zone 92 to flow into the lower annulus portion 104 and the screen assembly 50 of the lower equipment section 98 as is and becomes known.

Still referring to the example of FIG. 9, the valves 30 in each screen assembly 50 will allow fluid inflow from the annulus 88 into the corresponding base pipe 48, such as during production. However, when it is desired to run any fluid or mixture up or down the bore 16 of either base pipe 48, the valves 30 thereof will prevent the loss of fluid through the associated ports 20. For example, fluid may be delivered down through the bore 16 of the base pipe 48 in the upper section 96 to the lower section 98 of the system 80 without loss of fluid into the upper annulus portion 102. The reverse flow path is also possible, where fluid from the lower section 98 of the system 80 may be pushed up through the bore 16 of the base pipe 48 in the upper section 96 without loss of fluid into the annulus 102. Likewise, fluid may be pushed up or down the base pipe 48 of the lower section 98 without losing fluid to the lower annulus portion 104.

This arrangement may be useful, for example, in downhole procedures requiring fluid/mixture flow both up and down through the system 80 without loss through any screen assembly 50. In FIG. 9, a fluid or mixture is shown being pumped down through the upper section 96 via a passageway 108 formed in a concentric inner work string 110 and out into the lower annulus portion 104. The fluid, or a portion thereof, is thereafter recovered through one or more ports 20 in the base pipe 48 of the lower screen assembly 50 and directed up a passageway 112 of the inner work string 110 in the lower section 98. The fluid then passes into the bore 16 of the illustrated base pipe 48 in the upper section 96, where the corresponding valves 30 prevent loss through the screen assembly 50 and allow fluid delivery to surface (not shown). This flow pattern may be useful, for example, during well treatment operations in the lower annulus portion 104 and lower production zone 92. For example, the fluid/mixture delivered down into the lower annulus 104 may be proppant or sand and the fluid recovered through the lower screen assembly 50 may be the fluid carrier of the proppant or sand. For another example, the injected and recovered fluid may be clean fluid or include acid or another stimulating chemical.

In FIG. 10, fluid is shown being pumped down the bore 16 of the base pipe 48 in the upper section 96 and back up through the passageway 108 of the inner work string 110. The valves 30 in the base pipe 48 prevent the fluid from exiting through the screen assembly 50 into the upper annulus portion 102. The upper one-way flow system 10 is thus useful to bring fluid (excess proppant, sand, etc.) in the inner work string 100 to the surface (not shown). This may be useful, for example, during reverse-out procedures after treating the lower production zone 92. Otherwise, the system 80 is configured and operates as is or becomes known and may include additional components. For example, mechanical sliding sleeves (not shown) may be included to selectively close off the ports 30 of either base pipe 48 to prevent flow in either direction when desired.

Preferred embodiments of the present invention thus offer advantages over the prior art and are well adapted to carry out one or more of the objects of the invention. However, the present invention does not require each of the components and acts described above and is in no way limited to the above-described embodiments, methods of operation, variables, values or value ranges. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the invention and the appended claims should not be limited to the embodiments described and shown herein.

1. Apparatus for allowing one-way flow of fluid into or out of a tubular member useful in a well bore in connection with hydrocarbon recovery operations, the apparatus comprising:
a base pipe having a plurality of ports formed therein, each said port allowing fluid communication between the interior of said base pipe and the well bore; and
a plurality of one-way valves engaged with said base pipe, each said one-way valve being associated with one of said ports and at least substantially disposed within said associated port, each said one-way valve being capable of allowing fluid flow in one direction and at least substantially disallowing fluid flow in the opposite direction through said associated port.

2. The apparatus of claim 1 wherein each said one-way valve is acts independently of said other one-way valves and is non-mechanically actuated.

3. The apparatus of claim 2 further including at least one screen disposed around said plurality of ports of said base pipe.

4. The apparatus of claim 2 wherein each said one-way valve allows fluid flow into the interior of said base pipe through said associated port and at least substantially prevents fluid flow out of said base pipe through said associated port.

5. The apparatus of claim 2 wherein each said one-way valve allows fluid flow out of said base pipe through said associated port and at least substantially prevents fluid flow into said base pipe through said associated port.

6. The apparatus of claim 1 wherein each said one-way valve is biased in a closed position and is movable between a closed position and at least one open position based upon the differential pressure acting upon it.

7. The apparatus of claim 6 further including at least one screen disposed around said plurality of ports of said base pipe.

8. The apparatus of claim 6 wherein each said one-way valve includes at least one biasing member, at least one sealing member and at least one seat, wherein said at least one biasing member is capable of biasing said at least one sealing member in sealing engagement with said at least one seat.

9. The apparatus of claim 8 wherein each said one-way valve allows fluid flow into said base pipe through said associated port and at least substantially prevents fluid flow out of said base pipe through said associated port.

10. The apparatus of claim 8 wherein said at least one sealing member of each said one-way valve is constructed at least partially of a material capable of deteriorating upon sufficient contact with at least one deteriorating agent, whereby each said one-way valve allows bi-directional fluid flow through said associated port upon sufficient deterioration of said respective at least one sealing member.

11. The apparatus of claim 1 wherein each said one-way valve is capable of allowing bi-directional fluid flow through said associated port due to at least one among sufficient usage, passage of time and introduction of at least one valve deteriorating agent.

12. The apparatus of claim 11 wherein each said one-way valve includes at least one sealing member constructed at least partially of a material capable of deteriorating upon sufficient contact with at least one deteriorating agent.

13. Apparatus for allowing unidirectional flow of fluid into or out of a pipe string, the pipe string being disposed in a well bore, the apparatus comprising:
a base pipe having at least one port capable of allowing fluid communication between at least one bore of said base pipe and the well bore; and
at least one valve closure member anchored to said base pipe and associated with at least one said port,
said at least one valve closure member being biased in a closed position, wherein said at least one valve closure member in a closed position at least substantially prevents fluid flow through said at least one associated port,
said at least one valve closure member being movable into at least one open position based upon a sufficient change in the pressure differential between the well bore and said at least one bore of said base pipe, wherein said at least one valve closure member in an open position allows fluid flow through at least one said port.

14. The apparatus of claim 13 wherein the pipe string, said base pipe and said at least one valve closure member are useful in connection with hydrocarbon recovery operations, further including at least one screen extending concentrically around said at least one port of said base pipe.

15. The apparatus of claim 14 wherein each said valve closure member is at least substantially disposed within one said port and is non-mechanically actuated.

16. The apparatus of claim 15 wherein each said valve closure member allows fluid flow into at least one said bore of said base pipe through at least one said port and at least substantially prevents fluid flow out of said base pipe through said at least one port.

17. The apparatus of claim 15 wherein each said valve closure member includes at least one spring biasing member, at least one sealing member and at least one seat, wherein said at least one spring biasing member is capable of biasing said at least one sealing member in sealing engagement with said at least one seat.

18. A sand control-type screen assembly useful as part of a tubing string in a well bore in connection with hydrocarbon recovery operations, the sand control-type screen assembly comprising:
a base pipe having a wall and at least one port formed therein, each said port having a space extending at least partially between the inner diameter and the outer diameter of said base pipe, wherein each said port allows fluid communication between the interior and the exterior of said base pipe through said space of said port;
at least one non-mechanically actuated valve, each said valve being anchored to said base pipe, associated with one of said ports and biased in a closed position, wherein each said valve is capable of allowing fluid flow in one direction and disallowing fluid flow in the opposite direction through said associated port, and
at least one filter medium extending concentrically around said base pipe over said at least one port.

19. The sand control-type screen assembly of claim 18 wherein each said valve is fully contained within said area of said associated port.

20. The sand control-type screen assembly of claim 18 wherein each said valve extends outside said area of said associated port a distance of up to approximately one-half the average thickness of said wall of said base pipe.

21. The sand control-type screen assembly of claim 18 wherein each said valve acts independently of said other valves and is pressure-actuated from a spring-biased closed position to at least one open position.

22. The sand control-type screen assembly of claim 21 wherein each said valve allows fluid flow into the interior of said base pipe through said associated port and at least substantially prevents fluid flow in the opposite direction.

23. The sand control-type screen assembly of claim 18 wherein the sand control-type screen assembly is useful in a single trip multi-zone hydrocarbon well treatment/production system for at least one among well treatment and production at different respective formation production levels.

24. The sand control-type screen assembly of claim 23 further including multiple combinations of said base pipe, said at least one associated valve and said at least one associated filter medium, each said combination being disposed at a different respective zone of the single trip multi-zone hydrocarbon well treatment/production system.

25. The sand control-type screen assembly of claim 24 wherein a first upper combination of said base pipe, said associated at least one valve and said associated at least one filter medium is disposed in an upper zone of the single trip multi-zone hydrocarbon well treatment/production system and allows the communication of fluid between at least one fluid source at the surface and at least one lower zone of the single trip multi-zone hydrocarbon well treatment/production system without at least substantial fluid loss through said at least one filter medium.

26. The sand control-type screen assembly of claim 25 wherein each said valve is biased in a closed position and movable between closed and open positions based upon the application of sufficient pressure thereto.

27. The sand control-type screen assembly of claim 25 wherein said first upper combination of said base pipe, said associated at least one valve and said associated at least one filter medium allows reverse out procedures to be conducted at the upper zone of the single trip multi-zone hydrocarbon well treatment/production system without at least substantial fluid loss through said at least one filter medium.

28. A method of allowing one-way flow of fluid into a tubing string useful in a well bore in connection with hydrocarbon recovery operations, the method comprising:
providing a base pipe in the tubing string, the base pipe having a plurality of ports that allow fluid communication between the interior of base pipe and the well bore, each port having an associated valve that is spring-biased in a closed position relative to the associated port;
allowing fluid to flow axially through the base pipe without the fluid exiting through the plurality of ports;
upon sufficient application of fluid pressure on at least one valve from the well bore, allowing the at least one valve to open and permit the flow of fluid from the well bore through the associated at least one port and into the base pipe; and
upon a sufficient decrease in the application of fluid pressure on the at least one valve from the well bore, allowing the at least one valve to close and at least substantially prevent the flow of fluid through the associated at least one port.

29. A method of allowing one-way flow of fluid out of a tubing string useful in a well bore in connection with hydrocarbon recovery operations, the method comprising:
providing a base pipe in the tubing string, the base pipe having a plurality of ports that allow fluid communication between the interior of base pipe and the well bore, each port having an associated valve that is spring-biased in a closed position relative to the associated port;
upon sufficient application of fluid pressure on at least one valve from the interior of the base pipe, allowing the at least one valve to open and permit the flow of fluid from the base pipe through the associated at least one port and into the well bore; and
upon a sufficient decrease in the application of fluid pressure on the at least one valve from the interior of the base pipe, allowing the at least one valve to close and at least substantially prevent the flow of fluid through the associated at least one port.
